(19) United States
(12) Patent Application Publication
(10) Pub. No.: US 2025/0065164 A1
(43) Pub. Date: Feb. 27, 2025

(54) Method of Protecting An Occupancy Using A Pendent Fire Protection Sprinkler Arrangement Configured To Be Mounted In A Ceiling And Related Pendent Fire Protection Sprinkler Arrangement

(71) Applicant: The Reliable Automatic Sprinkler Co. Inc., Liberty, SC (US)

(72) Inventor: Juan Jimenez, Liberty, SC (US)

(21) Appl. No.: 18/945,742

(22) Filed: Nov. 13, 2024

Related U.S. Application Data
(62) Division of application No. 17/537,772, filed on Nov. 30, 2021.
Application No. 17/537,772 is a division of application No. 16/077,148, filed on Aug. 10, 2018, now Pat. No. 11,219,790.
(60) Provisional application No. 62/307,162, filed on Mar. 11, 2016.

(51) Int. Cl. A62C 31/02; A62C 37/11; B05B 1/26

(52) U.S. Cl. CPC A62C 31/02; A62C 37/11; B05B 1/265

(57) ABSTRACT

A method of protecting an occupancy, using a pendent fire protection sprinkler arrangement to be mounted in a ceiling, includes providing a plurality of pendent fire protection sprinklers, each having a sprinkler body having an inlet and an outlet defining a fluid passage and a sprinkler axis, and threads for connection to system piping of the occupancy. A pair of frame arms projects downwardly from the outlet and meet to form a junction. A plug seals a fluid passage, and a thermally responsive element between the plug and the junction retains the plug in the fluid passage. A deflector is mounted to the junction and includes a planar central portion extending outwardly from the sprinkler axis along a plane perpendicular to the sprinkler axis and first, second, third, and fourth angled portions bent away from the frame arms in the outlet direction from the plane of the planar central portion.

### CROSS REFERENCE TO RELATED APPLICATIONS

### Claim of Priority

This application is a divisional patent application of U.S. patent application Ser. No. 17/537,772, filed Nov. 30, 2021, which is a divisional patent application of U.S. patent application Ser. No. 16/077,148, filed Aug. 10, 2018, which is now U.S. Pat. No. 11,219,790, issued on Jan. 11, 2022, which application is a U.S. national stage application of International Patent Application No. PCT/US2017/021878, filed Mar. 10, 2017, which claims priority from U.S. Provisional Patent Application No. 62/307,162, filed Mar. 11, 2016.

### FIELD OF THE INVENTION

The invention relates to long-throw pendent fire protection sprinklers, and to deflectors included in long-throw pendent fire protection sprinklers for use in fire protection.

### DESCRIPTION OF RELATED ART

Pendent fire protection sprinklers are provided in ceilings to provide fire protection, and are designed to provide a specified amount of fluid to a specified area as a function of time. The specified area, known as the coverage area, is limited in maximum length by the capability of the pendent fire protection sprinkler to deliver the fluid to the perimeter of the coverage area. As the maximum length of the coverage area increases, a portion of the fluid output by the pendent fire protection sprinkler must have a higher velocity moving away from the sprinkler to reach the perimeter of the coverage area. This can be achieved by increasing the velocity of the fluid as it passes through an output orifice of the pendent fire protection sprinkler by, for example, increasing the fluid pressure in the supply piping. Increasing the fluid pressure in the supply piping, however, may require installation of relatively larger supply piping or a fire pump.

The Standard for the Installation of Sprinkler Systems, as set forth in the 2013 Edition published by the National Fire Protection Association, Inc., (NFPA 13), requires that pendent fire protection sprinklers providing extended coverage have a maximum spacing of 20 feet (6.096 meters). NFPA 13 § 8.8.2.1.2. Specialty upright fire protection sprinklers have been designed for specific applications, such as attics, with lengths of coverage areas of the specialty upright fire protection sprinklers exceeding 20 feet (6.096 meters). These specialty upright fire protection sprinklers must be installed a minimum of 16 inches (406.4 mm) below a peak (ceiling peak), and are installed under sloped roof decks. These specialty upright fire protection sprinklers cannot, however, be mounted close to the ceiling, or recessed therein, while maintaining a large length of coverage.

Horizontal sidewall fire protection sprinklers are also used to provide fire protection for coverage areas having large coverage lengths. Section 8.7.4.1.2.2 of the NFPA 13 requires that horizontal sidewall fire protection sprinklers be installed on a sidewall at least 4 inches (101.6 mm) below the ceiling. The position of the horizontal sidewall fire protection sprinkler below the ceiling is significant because droplets of the fluid discharged from the horizontal sidewall fire protection sprinkler are pulled towards the floor by gravity, and, in order to increase the coverage length of the coverage area for a horizontal sidewall fire protection sprinkler, a portion of the fluid sprayed from the horizontal sidewall fire protection sprinkler needs to be directed in an initially upward trajectory. This arrangement allows the fluid to travel farther horizontally from the horizontal sidewall fire protection sprinkler, because the amount of time between the output of the fluid from the horizontal sidewall fire protection sprinkler orifice to the fluid reaching the floor is relatively longer. Section 8.7.4.1.1.1 NFPA 13 requires that horizontal sidewall fire protection sprinklers have a minimum deflector to ceiling distance of 4 inches (101.6 mm), so that the fluid can be projected in an initially steep upward trajectory without striking the ceiling. Alternatively, vertical sidewall fire protection sprinklers may be installed in a pendent or an upright position while mounted on a sidewall. As provided in Tables 8.7.2.2.2 of NFPA 13, coverage areas for such fire protection sprinklers are limited to 14 feet by 14 feet (196 ft²) (4.26 meters by 4.26 meters) (18.21 square meters). Further, section 8.7.4.1 of NFPA 13 requires that vertical sidewall fire protection sprinklers have a minimum deflector to ceiling distance of 4 inches (101.6 mm), that allows the fluid to be projected with an initially steep upward trajectory similar to a horizontal sidewall fire protection sprinkler, unlike a ceiling-mounted pendent fire protection sprinkler.

### SUMMARY OF THE INVENTION

An objective of the present invention is to provide a method of protecting an occupancy using a pendent fire protection sprinkler arrangement configured to be mounted in a ceiling and a pendent fire protection sprinkler that overcomes the disadvantages discussed above.

To accomplish this objective, in one embodiment, the present invention provides a method of protecting an occupancy using a pendent fire protection sprinkler arrangement configured to be mounted in a ceiling. The method includes the steps of (A) providing a plurality of pendent fire protection sprinklers, each of the plurality of pendent fire protection sprinklers including (a) a sprinkler body having (i) an inlet at an inlet end, (ii) an outlet at an outlet end, the inlet and the outlet defining a fluid passage and a sprinkler axis, and (iii) threads for connection to system piping of the occupancy, (b) a pair of frame arms that project downwardly from the outlet end of sprinkler body that meet at a distance from the outlet end of the sprinkler body to form a junction, (c) a plug that seals the fluid passage, (d) a thermally responsive element provided between the plug and the junction for retaining the plug in the fluid passage, and (e) a deflector mounted to the junction, the deflector including (i) a planar central portion extending outwardly from the sprinkler axis along a plane that is perpendicular to the sprinkler axis, (ii) a first angled portion extending outwardly from the planar central portion in a first direction that is perpendicular to the sprinkler axis, (iii) a second angled portion extending outwardly from the planar central portion in a second direction that is perpendicular to the sprinkler axis, and collinear with and opposite to the first direction, (iv) a third angled portion extending outwardly from the planar central portion in a third direction that is perpendicular to the sprinkler axis, the first direction, and the second direction, and (v) a fourth angled portion extending outwardly from a planar central portion in a fourth direction that is perpendicular to the sprinkler axis, and collinear with and opposite to the third direction, wherein the first, second, third, and fourth angled portions are bent away from the frame arms in the outlet direction from the plane of the planar central portion. The method also includes (B) connecting each of the plurality of pendent fire protection sprinklers to the system piping of the occupancy using the threads of each pendent fire protection sprinkler, wherein, when each of the plurality of pendent fire protection sprinklers is connected to the system piping of the occupancy, the outlet end of each of the plurality of pendent fire protection sprinklers is within two inches of a surface of the ceiling, and wherein each of the plurality of pendent fire protection sprinklers has a rectangular coverage area including a length along a long axis and a width along a short axis, the long axis and the short axis being perpendicular to each other, the length being from twenty feet up to thirty-five feet.

In another embodiment, a pendent fire protection sprinkler comprises a sprinkler body having an inlet at an inlet end, and an outlet at an outlet end, the inlet and the outlet defining a fluid passage and a sprinkler axis, a pair of frame arms that project downwardly from the outlet end of the sprinkler body that meet at a distance from the outlet end of the sprinkler body to form a junction, a plug that seals the fluid passage, a thermally responsive element provided between the plug and the junction and configured to maintain the plug in the passage prior to actuation of the pendent fire protection sprinkler, and a deflector mounted to the junction. The deflector comprises a planar central portion extending outward from the sprinkler axis along a plane that is perpendicular to the sprinkler axis, a first angled portion extending outward from the planar central portion in a first direction that is perpendicular to the sprinkler axis, and a second angled portion extending outward from the planar central portion in a second direction that is perpendicular to the sprinkler axis, and collinear with and opposite to the first direction. The deflector also comprises a third angled portion extending outward from the planar central portion in a third direction that is perpendicular to the sprinkler axis, the first direction, and the second direction, and a fourth angled portion extending outward from a planar central portion in a fourth direction that is perpendicular to the sprinkler axis, and collinear with and opposite to the third direction. The first, second, third, and fourth angled portions are bent away from the frame arms in the outlet direction from the plane of the planar central portion.

In another embodiment, a pendent fire protection sprinkler arrangement is configured to be installed in a ceiling, and comprises at least one pendent fire protection sprinkler comprising a sprinkler body having an inlet at an inlet end, an outlet at an outlet end, the inlet and the outlet defining a fluid passage and a sprinkler axis, and threads for connection to sprinkler system piping, wherein, when the pendent fire protection sprinkler is installed in the ceiling, the outlet end is within two inches of a surface of the ceiling. The pendent fire protection sprinkler further comprises a pair of frame arms that project downwardly from the outlet end of the sprinkler body and meet at a distance from the outlet end of the sprinkler body to form a junction, a plug that seals the fluid passage, a thermally responsive element provided between the plug and the junction for retaining the plug in the fluid passage, and a deflector mounted to the junction. The deflector comprises a planar central portion extending outward from the sprinkler axis along a plane that is perpendicular to the sprinkler axis, a first angled portion extending outward from the planar central portion in a first direction that is perpendicular to the sprinkler axis, and a second angled portion extending outward from the planar central portion in a second direction that is perpendicular to the sprinkler axis, and collinear with and opposite to the first direction. The deflector also comprises a third angled portion extending outward from the planar central portion in a third direction that is perpendicular to the sprinkler axis, the first direction, and the second direction, and a fourth angled portion extending outward from a planar central portion in a fourth direction that is perpendicular to the sprinkler axis, and collinear with and opposite to the third direction. The first, second, third, and fourth angled portions are bent away from the frame arms in the outlet direction from the plane of the planar central portion, and the at least one pendent fire protection sprinkler has a rectangular coverage area comprising a length along a long axis and a width along a short axis, the long axis and the short axis being perpendicular to each other, and the length being from 20 feet up to 35 feet.

### BRIEF DESCRIPTION OF THE DRAWINGS

FIG. 1 is an isometric view of a pendent fire protection sprinkler in accordance with an embodiment of the invention.

FIG. 2 is a side view of a pendent fire protection sprinkler in accordance with an embodiment of the invention.

FIG. 3 is a top view of a deflector of a pendent fire protection sprinkler in accordance with an embodiment of the invention.

FIG. 4 is a cross-sectional side view of a deflector of a pendent fire protection sprinkler in accordance with an embodiment of the invention.

FIG. 5 is a side view of a deflector of a pendent fire protection sprinkler in accordance with an embodiment of the invention.

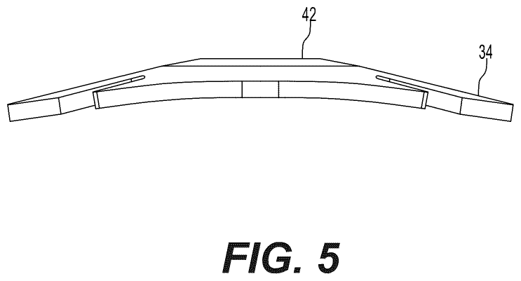

### DETAILED DESCRIPTION OF THE EMBODIMENTS

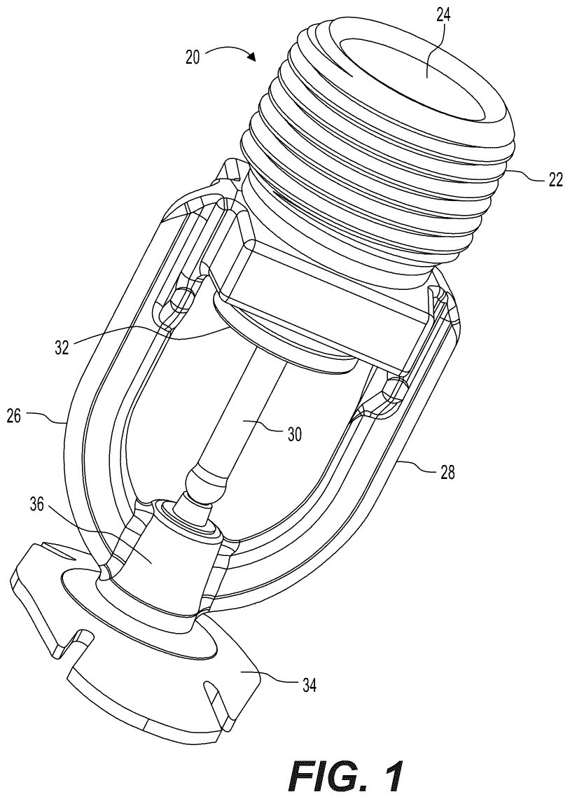

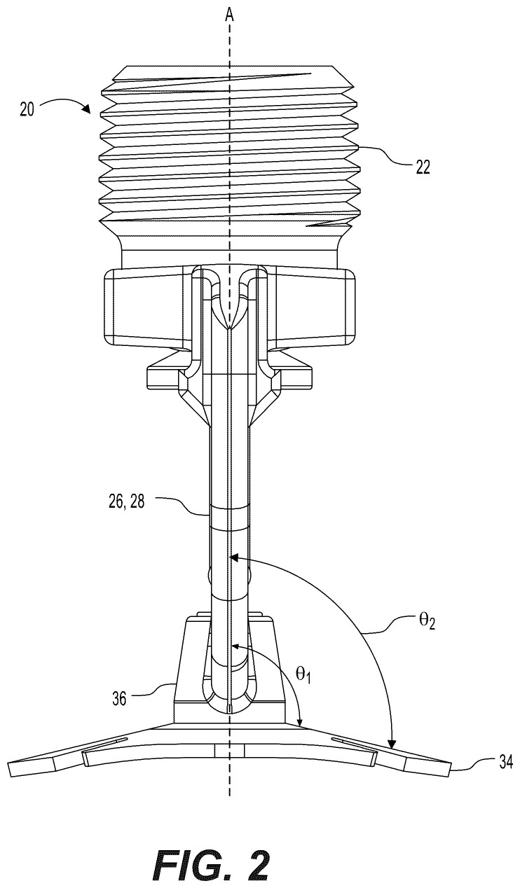

FIGS. 1 and 2 show one embodiment of a pendent fire protection sprinkler 20 of the invention. The pendent fire protection sprinkler 20 includes a sprinkler body 22 having an inlet at an inlet end, an outlet (not shown) at an outlet end, and a fluid passage 24 for the fluid. A sprinkler axis A extends along the fluid passage 24. The inlet end of the pendent fire protection sprinkler 20 has threads for connection to piping of a sprinkler system, and the fluid passage 24 extends from the inlet end to the outlet end. When the pendent fire protection sprinkler 20 is installed in a ceiling, the outlet end is located within 2 inches (50.8 mm) of the ceiling. One or more frame arms 26, 28 project downward from the sprinkler body 22, e.g., on either side of the sprinkler axis A. If more than one frame arm 26, 28 is provided, the plurality of frame arms 26, 28 may form a junction 36 at their respective lower ends (i.e., the outlet end of the pendent fire protection sprinkler 20). A plug 32 seals the fluid passage 24 in the sprinkler body 22, and a thermally responsive element 30 is provided between the plug 32 and the junction 36. The thermally responsive element 30 holds the plug 32 in place, sealing the orifice of the fluid passage 24 until actuation of the pendent fire protection sprinkler 20. A deflector 34 is mountable to the junction 36 at the end of the one or more frame arms 26, 28, at an opening 38 in the deflector 34.

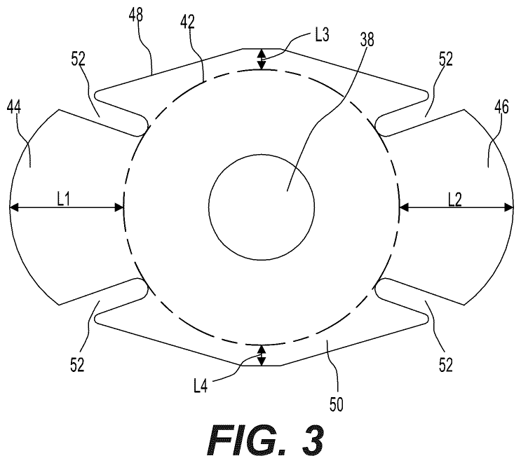

The deflector 34 is arranged to direct fluid in a generally horizontal direction when the pendent fire protection sprinkler 20 is mounted in the ceiling. That is, for the purpose of directing fluid in a generally horizontal direction, the deflector 34 has a central portion 42 that extends outward from the sprinkler axis A, generally along a plane perpendicular to the sprinkler axis A. In a typical embodiment, the central portion 42 may be bent relative to the sprinkler axis A at a first angle θ₁. The deflector 34 also includes at least one outer angled portion 44, 46, 48, 50 that extends from an outer peripheral edge of the central portion 42 at a second angle θ₂ that is greater than the first angle θ₁ with respect to the sprinkler axis A. The outer angled portion includes a first angled portion 44 extending outward from the peripheral edge of the central portion 42, at the second angle θ₂ from the sprinkler axis A, in a first direction, and has a length L1, as shown in FIG. 3. A second angled portion 46 extends outward from the peripheral edge of the central portion 42, at the second angle θ₂ from the sprinkler axis A, in a second direction, and has a length L2. The first and second directions may be opposite to each other with respect to the sprinkler axis A. In addition, a third angled portion 48 may be provided on the outer angled portion, extending outward from the peripheral edge of the central portion 42 in a third direction, and has a length L3. A fourth angled portion 50 extends outward from the peripheral edge of the central portion 42, in a fourth direction, and has a length L4. The third and fourth directions may be opposite to each other with respect to the sprinkler axis A. That is, the first and second angled portions 44, 46 are provided on opposing sides of the central portion 42 with respect to the sprinkler axis A, and produce the length of the rectangular coverage area of the installed pendent fire protection sprinkler 20, and the third and fourth angled portions are provided on opposing sides of the central portion 42 with respect to the sprinkler axis A, and produce the width of the rectangular coverage area of the installed pendent fire protection sprinkler 20.

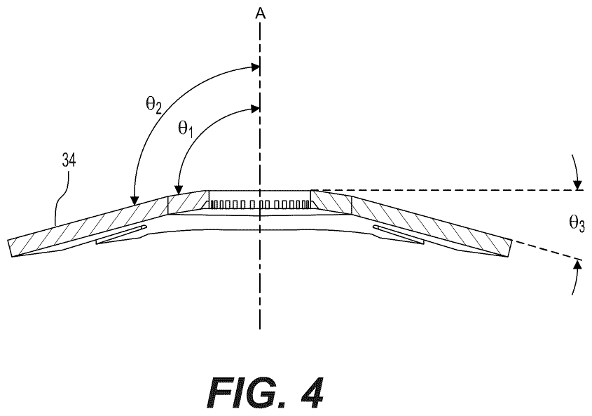

As shown in FIG. 2, each of the first angled portion 44, the second angled portion 46, the third angled portion 48, and the fourth angled portion 50 may be bent at the second angle θ₂ from the sprinkler axis A, in a downward direction (i.e., in the output direction). The second angle θ₂ is preferably at least 1040 relative to the sprinkler axis A. Alternatively, as shown in FIG. 4, the first to fourth angled portions 44, 46, 48, and 50 may be bent at an angle θ₃ relative to a horizontal plane that is perpendicular to the sprinkler axis A, with θ₃ being approximately 14°. This angle may ordinarily be the same for the first to fourth angled portions 44, 46, 48, and 50, although it is within the broader scope of the invention for the first to fourth angled portions 44, 46, 48, and 50 to be bent at two, three, or four different angles. As noted above, and as shown in FIG. 3, the first angled portion 44 and the second angled portion 46 may be symmetrical to each other with respect to the sprinkler axis A, and the third angled portion 48 and the fourth angled portion 50 may be symmetrical to each other with respect to the sprinkler axis A.

In a typical embodiment, the combination of the lengths L1 and L2, representing the length of the first angled portion 44 and the second angled portion 46 of the deflector 34, is 1.46 inches (37.08 mm) (L1 and L2 may each be half of that combined length, or 0.72 inch (18.54 mm) as measured from the sprinkler axis A), and the combination of the lengths L3 and L4 representing the width of the deflector 34 is 0.92 inch (23.37 mm) (L3 and L4 may each be half of that combined length, or 0.46 inch (11.68 mm) as measured from the sprinkler axis A). The opening 38 of the deflector 34 may have a diameter of 0.306 inch (7.77 mm), and the central portion 42 may have a diameter of 0.567 inch (14.40 mm). The lengths L1 and L2 are measured generally along a long axis L of the deflector 34, and the lengths L3 and L4 are measured generally along a short axis S of the deflector 34. In a typical embodiment, a width of the coverage area along the short axis S is less than a length of the coverage area along the long axis L. For example, the width of the coverage area along the short axis S is 14 feet (4.27 m), and the length of the coverage area along the long axis L is 28 feet (8.53 m).

Spaces, or slots, 52 are provided between adjacent angled portions 44, 46, 48, and 50, as shown in FIG. 3. The width of the slot 52 between a side edge of the first angled portion 44 and an adjacent side edge of either one of the third angled portion 48 and fourth angled portion 50 may be 0.06 inch (1.52 mm). Similarly, the width of the slot 52 between a side edge of the second angled portion 46 and a side edge of either one of the adjacent third angled portion 48 or fourth angled portion 50 may also be 0.06 inch (1.52 mm). The slots 52 allow some of the fluid that flows out of the fluid passage 24 to flow downward (i.e., along the outlet direction), in addition to the fluid being deflected horizontally by the deflector 34. While the slots 52 are generally oriented radially with respect to the sprinkler axis A, the slots 52 do not lie precisely along a radius of the central portion 42 of the deflector 34, and instead, an axis of each slot 52 is offset from the radius of the central portion 42. That is, the axes of opposing slots 52 are not collinear, and instead are parallel to each other and offset from each other by a distance of, e.g., 0.20 inch (5.08 mm), and are offset an equal distance from a diametric line that passes through the sprinkler axis A. In addition, in another embodiment, the first and second angled portions 44, 46 may have a rounded peripheral edge, while the third and fourth angled portions 48, 50 may have a peripheral edge that is rectilinear, with one or more straight edge portions, as shown in FIG. 3.

In a preferred embodiment, a portion of the pendent fire protection sprinkler 20 is mounted in the ceiling so that a minimum distance between the deflector 34 and the ceiling is 1 inch (25.4 mm). Alternatively, the pendent fire protection sprinkler 20 may be mounted in a recess in the ceiling, such that a minimum distance between the deflector 34 and the ceiling is 0.75 inch (19.05 mm). The pendent fire protection sprinklers 20 having the structure disclosed herein may be spaced over 20 feet (6.10 m) apart, up to 28 feet (8.53 m) apart, and water distribution that meets the requirements set forth in NFPA 13 can be obtained over a 392 square foot (36.42 m²) area.

The pendent fire protection sprinkler 20 may have a K-factor in the range of 3 gpm/(psi)^{1/2} to 30 gpm/(psi)^{1/2}, the K-factor being defined as K where Q is the flow rate from the outlet of the pendent fire protection sprinkler 20 in gallons per minute, and p is the residual pressure at the inlet of the pendent fire protection sprinkler 20 in pounds per square inch. More particularly, the pendent fire protection sprinkler 20 may have a K-factor in the range of 5.6 gpm/(psi)^{1/2} to 14.8 gpm/(psi)^{1/2}, and most preferably, the pendent fire protection sprinkler 20 may have a K-factor of 5.6 gpm/(psi)^{1/2}.

As noted above, each pendent fire protection sprinkler 20 that may be used in a pendant sprinkler arrangement, as described above, has a rectangular coverage area comprising the long axis L and the short axis S. The long axis L is perpendicular to the short axis S, and the long axis L may extend from 20 to 35 feet (6.10 to 10.67 m).

While the present invention has been described with respect to what are, at present, considered to be the preferred embodiments, it is to be understood that the invention is not limited to the disclosed embodiments. To the contrary, the invention is intended to cover various modifications and equivalent arrangements included within the spirit and scope of the appended claims.

1. A method of protecting an occupancy using a pendent fire protection sprinkler arrangement configured to be mounted in a ceiling, the method comprising the steps of:
(A) providing a plurality of pendent fire protection sprinklers, each of the plurality of pendent fire protection sprinklers including:
(a) a sprinkler body having (i) an inlet at an inlet end, (ii) an outlet at an outlet end, the inlet and the outlet defining a fluid passage and a sprinkler axis, and (iii) threads for connection to system piping of the occupancy;
(b) a pair of frame arms that project downwardly from the outlet end of sprinkler body that meet at a distance from the outlet end of the sprinkler body to form a junction;
(c) a plug that seals the fluid passage;
(d) a thermally responsive element provided between the plug and the junction for retaining the plug in the fluid passage; and
(e) a deflector mounted to the junction, the deflector comprising:
(i) a planar central portion extending outwardly from the sprinkler axis along a plane that is perpendicular to the sprinkler axis;
(ii) a first angled portion extending outwardly from the planar central portion in a first direction that is perpendicular to the sprinkler axis;
(iii) a second angled portion extending outwardly from the planar central portion in a second direction that is perpendicular to the sprinkler axis, and collinear with and opposite to the first direction;
(iv) a third angled portion extending outwardly from the planar central portion in a third direction that is perpendicular to the sprinkler axis, the first direction, and the second direction; and
(v) a fourth angled portion extending outwardly from a planar central portion in a fourth direction that is perpendicular to the sprinkler axis, and collinear with and opposite to the third direction,
wherein the first, second, third, and fourth angled portions are bent away from the frame arms in the outlet direction from the plane of the planar central portion; and
(B) connecting each of the plurality of pendent fire protection sprinklers to the system piping of the occupancy using the threads of each pendent fire protection sprinkler,
wherein, when each of the plurality of pendent fire protection sprinklers is connected to the system piping of the occupancy, the outlet end of each of the plurality of pendent fire protection sprinklers is within two inches of a surface of the ceiling, and
wherein each of the plurality of pendent fire protection sprinklers has a rectangular coverage area comprising a length along a long axis and a width along a short axis, the long axis and the short axis being perpendicular to each other, the length being from twenty feet up to thirty-five feet.

2. A pendent fire protection sprinkler arrangement comprising:
(A) a sprinkler body having (i) an inlet at an inlet end, (ii) an outlet at an outlet end, the inlet and the outlet defining a fluid passage and a sprinkler axis;
(B) at least one frame arm projecting from the sprinkler body and having a distal end remote from the sprinkler body;
(C) a plug that seals the fluid passage;
(D) a thermally responsive element provided between the distal end of the at least one frame arm and the plug, and retaining the plug in the fluid passage; and
(E) a deflector supported by the at least one arm at a distance from the outlet, and provided at a position to intercept fluid emitted from the outlet, the deflector comprising:(a) a central portion extending outward from the sprinkler axis; and
(b) at least a peripheral portion that is angled with respect to the central portion and extends outwardly from the central portion to direct a fluid to a coverage area of the pendent fire protection sprinkler, the coverage area being generally rectangular and having a length along a long axis and a width along a short axis that is transverse to the long axis,
wherein the angle between the central portion and the peripheral portion directs the fluid in at least one direction, that is generally parallel to the long axis of the coverage area, a distance greater than ten feet from the sprinkler axis.

3. The pendent fire protection sprinkler arrangement according to claim 2, wherein the angle between the central portion and the peripheral portion directs the fluid generally parallel to the long axis of the coverage area without causing the fluid to strike a ceiling that is located over the coverage area and is vertically within two inches of the deflector.

4. The pendent fire protection sprinkler arrangement according to claim 2, wherein the central portion of the deflector is at a first angle with respect to the sprinkler axis, and the second portion is at a second angle with respect to the sprinkler axis.

5. The pendent fire protection sprinkler arrangement according to claim 2, wherein the first angle is less than the second angle.

6. The pendent fire protection sprinkler arrangement according to claim 2, wherein the deflector further comprises at least one slot formed on an outer peripheral surface of the peripheral portion.

7. The pendent fire protection sprinkler arrangement according to claim 2, wherein the width of the coverage area in a direction along the short axis is less than approximately fourteen feet, is less than the length of the coverage area in a direction along the long axis, and the width and the length define a rectangular coverage area.

8. The pendent fire protection sprinkler arrangement according to claim 2, wherein the pendent fire protection sprinkler has a K-factor ranging from three gpm/psi^{1/2} to thirty gpm/psi^{1/2}.
